(19) United States
(12) Patent Application Publication
(10) Pub. No.: US 2010/0255288 A1
(43) Pub. Date: Oct. 7, 2010

(54) SOLID DIELECTRIC MATERIAL FOR FLUID-FILLED TRANSFORMER

(76) Inventors: Thomas M. Golner, Lakeview, WI (US); Shirish P. Mehta, Apache Pass, WI (US); Jeffrey J. Nemec, Oconomowoc, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/418,651

(22) Filed: Apr. 6, 2009

(51) Int. Cl. B32B 3/26; B05D 3/02; C09J 5/02; B05D 3/00; C08J 9/00

(52) U.S. Cl. 428/321.1; 428/221; 427/385.5; 156/307.3; 427/294; 521/178

(57) ABSTRACT

A dielectric material that includes an epoxy matrix and a high-voltage dielectric insulating fluid. The epoxy matrix includes a porosity of at least 20% by volume and at least 90% of the porosity is in the matrix is accessible to the insulating fluid. Also, a method of forming a dielectric material with such high porosity and impregnability by an insulating fluid.

### FIELD OF THE INVENTION

The present invention relates generally to dielectric materials used as parts of insulation systems utilized in transformers. The present invention also relates generally to methods of fabrication of dielectric materials used in transformers.

### BACKGROUND OF THE INVENTION

Currently available high-voltage power transformers utilize cellulose-based insulation materials that are impregnated with dielectric fluids. The insulation systems for currently available power transformers include insulation between turns, insulation between disc and sections, layer insulation, insulation between windings and insulation between components at high voltage and ground potential parts such as cores, structural members and tanks.

The above-mentioned dielectric-fluid-impregnated cellulosic insulation components have certain performance issues over the life of the transformer. As such, these require special processes, design considerations and application considerations for use in power transformers. For example, cellulose, being a natural fiber, is subject to variations in certain properties that are important in proper functioning of the transformer during a long, trouble-free operational life. More specifically, the use of cellulose based insulation materials limits maximum operating temperature. Further, such materials require special processes for stabilization and dry out to reduce moisture content of the insulation system.

In actual operation, all insulation systems age and degrade. Degradation of the insulation system results in the reduced life of a transformer. Also, ageing of the insulation system degrades the performance of the power transformer over time. The rate of degradation is a complex function of the operating temperature, moisture content and oxygen content of the insulation system.

### SUMMARY OF THE INVENTION

At least in view of the above, it would be desirable to have dielectric materials that are more consistent. It would also be desirable for such materials to have more predictable and improved performance with respect to ageing as result of the effects of temperature, moisture and oxygen. It would be further desirable to have dielectric materials that provide better mechanical properties and dimensional stability under pressure over the life of a power transformer without requiring special processes.

In addition to the above, it would also be desirable to provide novel dielectric materials that could be either used for or incorporated into insulation for power transformers. It would be particularly useful for these novel dielectric materials to be resistant to deterioration by being particularly designed to withstand relatively high operating voltages and operating temperatures. It would also be desirable to provide novel methods of forming such dielectric materials and insulations.

The foregoing needs are met, to a great extent, by one or more embodiments of the present invention. According to one such embodiment, a dielectric material is provided. The dielectric material includes an epoxy matrix having a porosity of at least 20% by volume. The dielectric material also includes a high-voltage dielectric insulating fluid, wherein at least 90% of the porosity is filled with the insulating fluid.

In accordance with another embodiment of the present invention, a method of forming a dielectric material is provided. The method includes mixing an epoxy resin with an epoxy-curing agent, a foaming agent and a solvent to form a mixture. The method also includes curing the mixture to form a matrix having at least 20% porosity by volume. The method further includes back-filling at least 90% of the porosity with a high-voltage dielectric insulating fluid.

In accordance with yet another embodiment of the present invention, another dielectric material is provided. The dielectric material includes means for mixing an epoxy resin with an epoxy-curing agent, a foaming agent and a solvent to form a mixture. The dielectric material also includes means for curing the mixture to form a matrix having at least 20% porosity by volume. The dielectric material further includes means for back-filling at least 90% of the porosity with a high-voltage dielectric insulating fluid.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic representation of chemical components that are mixed together according to an embodiment of the present invention;

FIG. 2 is a cross-sectional view of a portion of a dielectric material according to an embodiment of the present invention; and

FIG. 3 is a schematic representation of a step in a method of manufacturing a dielectric material according to an embodiment of the present invention; and

FIG. 4 is a flowchart illustrating steps of a method of forming a dielectric material according to an embodiment of the present invention.

### DETAILED DESCRIPTION

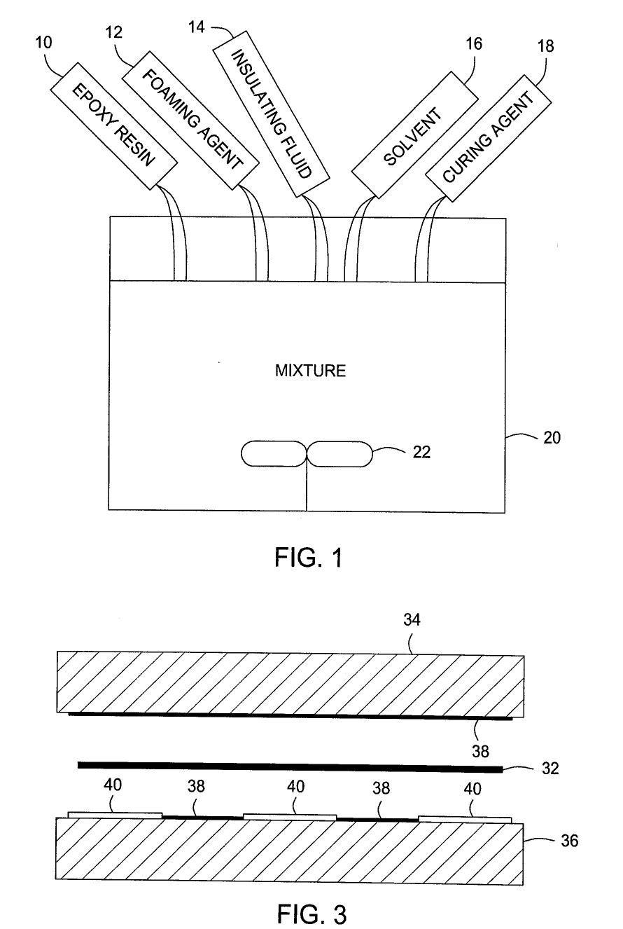

Embodiments of the present invention will now be described with reference to the drawing figures, in which like reference numerals refer to like parts throughout. FIG. 1 is a schematic representation of a set of chemical components that are mixed together according to an embodiment of the present invention. More specifically, according to certain embodiments of the present invention, one or more of an epoxy resin 10, a foaming agent 12, an insulating fluid 14 (e.g., an electrical or dielectric insulating fluid), a solvent 16 and a curing agent 18 are combined to form a mixture 20. Also illustrated in FIG. 1 is a stirring mechanism 22 that may be used to promote homogeneity of the mixture 20.

According to certain embodiments of the present invention, the chemical components are added individually. According to other embodiments of the present invention, two or more of the chemical components are added to the mixture 20 at substantially the same time. The stirring mechanism 22 may be operated either continuously as chemical components are added or may be operated intermittently. Also, as will be described below in conjunction with the discussion of methods according to the present invention, the mixture 20 may be heated, either continuously or intermittently as and after one or more chemical components are added.

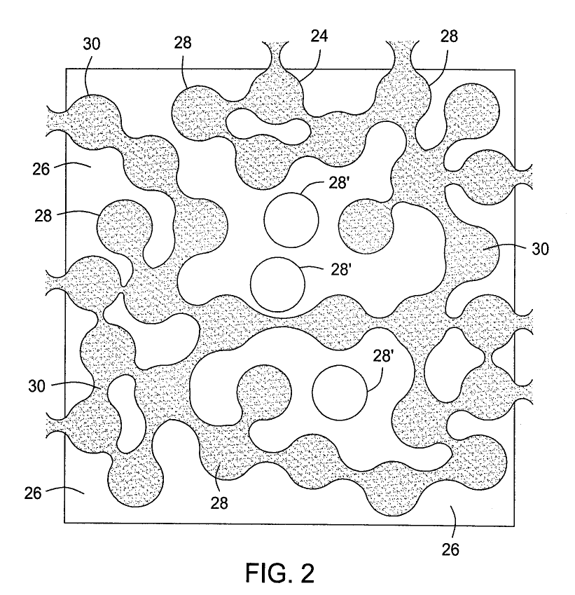

FIG. 2 is a cross-sectional view of a portion of a dielectric material 24 according to an embodiment of the present invention. As illustrated in FIG. 2, the dielectric material 24 includes an epoxy matrix 26, a plurality of interconnected pores 28, some of which are open to the exterior of the matrix 26, and a few isolated pores 28′. Although a very high percentage of porosity is illustrated in the dielectric material 24 illustrated in FIG. 2, a porosity of 20% by volume (or less) is also within the scope of certain embodiments of the present invention, as are higher porosity percentages such as, for example, 25%, 30%, 35%, 40%, 45%, 50%, 55%, 60%, 65%, 70%, 75% and higher by volume. In fact, all porosity percentages that allow for the dielectric material 24 to retain the amount of mechanical stability desirable for inclusion in a power transformer are within the scope of the present invention.

Within the pores 28 illustrated in FIG. 2 is illustrated an insulating fluid 30. More specifically, the insulating fluid 30 illustrated in FIG. 2 is a high-voltage dielectric insulating fluid that may, for example, flow into the pores 28 from outside of the matrix 26 as illustrated in FIG. 2. In FIG. 2, the insulating fluid 30 fills substantially all of the interconnected pores 28 but none of the isolated pores 28′. According to certain embodiments of the present invention, at least 90% of the porosity within the dielectric material 24 is accessible to, and typically also therefore substantially filled with, the insulating fluid 30. According to other embodiments of the present invention, the percentage of the porosity that is accessible to the insulating fluid 30 may be at least 30%, at least 40%, at least 50%, at least 60%, at least 70%, at least 75%, at least 80%, at least 85% and at least 95%. Also, any other percentage of insulating fluid-inclusion that supports satisfactory operation of the dielectric material 24 within a power transformer is also within the scope of certain embodiments of the present invention.

In order to promote accessibility of the pores 28, relatively brittle sponge materials are used as the matrix 26 according to certain embodiments of the present invention. These types of materials allow for relatively easy rupture of portions of walls between pores 28 that would otherwise isolate the pores if not ruptured.

According to certain embodiments of the present invention, the epoxy matrix 26 illustrated in FIG. 2 is formed from the epoxy resin 10 and the curing agent 18 illustrated in FIG. 1, wherein the curing agent 18 is selected so as to be capable of curing the epoxy resin 10. Typically, heat is also used during the curing process. This heating will be elaborated upon further in the discussion provided below of methods of forming dielectric materials according to certain embodiments of the present invention.

No particular restrictions are made upon the epoxy resin 10 used to form the epoxy matrix 26. However, according to certain embodiments of the present invention, the epoxy resin 10 includes one or more of a polyglycidyl compound and a phenol novolac epoxy.

According to certain embodiments of the present invention, the epoxy matrix 26 illustrated in FIG. 2 is solidified from the mixture 20 illustrated in FIG. 1 when the mixture 20 that includes the solvent 16 illustrated in FIG. 1. Although no particular restrictions are made on the type of solvent 16 used, according to certain embodiments of the present invention, the solvent 16 includes at least one of methyl isobutyl ketone (MIBK), methyl isoamyl ketone, toluene and n-butanoland xylene. According to certain embodiments of the present invention, not all of the solvent 16 boils off during curing of the epoxy resin 10. Rather, according to some of these embodiments, the solvent 16 boils off after the matrix 26 is largely or fully formed and ruptures some of the walls between pores in the matrix 26, thereby leading to an open porous structure.

As mentioned above, the selection of the curing agent 18 depends on the selection of the epoxy resin 10. More specifically, the curing agent 18 is chosen based upon its ability to cure the resin 10. According to certain embodiments of the present invention, the curing agent 18 includes one or more of an aliphatic amine, an aromatic amine and a fatty polyamide. However, other curing agents 18 are also within the scope of the present invention.

In order to obtain the desired porosity in the epoxy matrix 26 illustrated in FIG. 2, the foaming agent 12 illustrated in FIG. 1 is used according to certain embodiments of the present invention. The foaming agent 12 may be activated in a purely chemical manner as it comes into contact with other components in the mixture 20. As an alternative, the foaming agent 12 may be thermally activated during the curing process. According to certain embodiments of the present invention, residual foaming agent 12 may be removed from the pores 28, 28′ using heat (i.e., to “burn out” any residual foaming agent 12) or one or more liquids to “flush out” any residual foaming agent 12. The foaming agent 12 illustrated in FIG. 1 may include, for example, methyl hydrogen siloxane. However, other foaming agents 12 are also within the scope of the present invention.

The insulating fluid 14 illustrated in FIG. 1 and the insulating fluid 30 illustrated in FIG. 2 may be made up of substantially different materials according to certain embodiments of the present invention. However, according to other embodiments, the insulating fluids 14, 30 are made up of substantially identical materials. For example, according to certain embodiments of the present invention, one or both of the insulating fluids 14, 30 include one or more of a napthenic mineral oil, a paraffinic-based mineral oil, synthetic esters and natural esters (e.g., FR3™).

Regardless of whether or not they include substantially the same material(s), several differences nonetheless exist between the insulating fluid 14 illustrated in FIG. 1 and the insulating fluid 30 illustrated in FIG. 2. For example, the insulating fluid 14 illustrated in FIG. 1 is typically added to the mixture 20 before the epoxy resin 10 has cured (i.e., before the epoxy matrix 26 illustrated in FIG. 2 has formed). In contrast, the insulating fluid 30 illustrated in FIG. 2 is typically incorporated into the dielectric material 24 after the epoxy matrix 26 has achieved some structural integrity.

For example, according to certain embodiments of the present invention, once the epoxy matrix 26 is mechanically stable, the dielectric material 24 is submerged in a bath of insulating fluid. The, the insulating fluid 30 flows into the interconnected pores 28 illustrated in FIG. 2. When the insulating fluid 14 is added to the mixture 20 while or before the epoxy matrix 26 forms, then the insulating fluid 14 typically coats at least some of the exposed surfaces of the pores 28, 28′. Thus, the insulating fluid 14 on the surface of the pores 28 effectively aid in “wicking” the insulating fluid 30 into the epoxy matrix 26 due to the relatively favorable surface energies of the pores 28.

Another representative manner in which the insulating fluid 14 illustrated in FIG. 1 and the insulating fluid 20 illustrated in FIG. 2 differ is in the amount of each that is used. For example, according to certain embodiments of the present invention, the insulating fluid 14 illustrated in FIG. 1 makes up only between approximately 1.0 and 2.0 weight percent of the overall mixture 20. In contrast, according to certain embodiments of the present invention, the insulating fluid 30 illustrated in FIG. 2 can make up, for example, 15, 18, 20, 25, 30, 35, 40 or more volume percent of the overall dielectric material 24. Regardless of variations in the relative densities of the insulating fluids 14, 30 and dielectric material 24 from embodiment to embodiment of the present invention, the amount of the insulating fluid 14 illustrated in FIG. 1 is typically significantly less than the amount of insulating fluid 30 illustrated in FIG. 2. In fact, according to certain embodiments of the present invention, the insulating fluid 14 merely coats a portion of the pores 28, 28′ while the insulating fluid 30 substantially fills the pores 28.

FIG. 3 is a schematic representation of a step in a method of manufacturing a dielectric material according to an embodiment of the present invention wherein a polymer material is adhered to the epoxy matrix 26 illustrated in FIG. 2. According to certain embodiments of the present invention, the polymer material includes at least one of a polyester, a polyphenylene sulphide, an aramide, a polyetherimide, a polysulphone and a polyether sulphone. However, other materials may also be used. Materials that are particularly useful are those synthetic materials that have similar or lower dielectric constants than the cellulosic materials that are currently used. Materials that absorb less moisture than cellulosic materials are also particularly desirable.

As will be discussed below, a mixture of an epoxy resin, an epoxy curing agent, a foaming agent and a solvent is dispersed under controlled conditions into a polymer fiber matrix. The process is repeated until desired dimensions are realized and is typically carried out under controlled temperature, pressure and duration to promote uniformity, open pore structure and a porosity of at least 20% by volume. This open pore structure facilitates uniform impregnation of a dielectric fluid in the dielectric material.

More specifically, in FIG. 3, a polyester layer 32 is illustrated as being positioned between a top platen 34 and a bottom platen 36, one, both or neither of which may be heated, depending upon the particular embodiment of the invention. Also illustrated in FIG. 3 is a pair of release layers 38, each of which is located on one a surface of one of the platens 34, 36 positioned closest to the polyester layer 32. Each of these release layers 38 is typically made from a non-stick material such as, for example, poly(tetrafluoroethylene). However, one or more of the release layers 28 may also include a surface release agent directly applied to the mold surface such as a silicone material or solvent-born thermoplastic release compound.

In addition to the components mentioned above, a set of shims 40 are also illustrated in FIG. 3. The shims 40 illustrated in FIG. 3 are positioned on the surface of the bottom platen 36 that is closest to the polyester layer 32. However, according to other embodiments of the present invention, one or more shims 40 may be positioned on and/or adjacent to the top platen 34, either in addition to or in lieu of the shims 32 located on the bottom platen 36. Regardless of where the shims 40 are located between the platens 34, 36, the shims 40 typically ensure that a gap continues to exist between the platens 34, 36 (i.e., the shims 40 prevent the surfaces of the platens 34, 36 closest to the polyester layer 32 from ever coming into contact with each other).

As will be discussed in more detail below, when forming a dielectric material according to certain embodiments of the present invention, some of the mixture 20 illustrated in FIG. 1 is placed between the platens 34, 36 illustrated in FIG. 3. The mixture 20 may be placed on one or both sides of the polyester layer 32. Then, according to certain embodiments of the present invention, as the mixture 20 cures to become the epoxy matrix 26 illustrated in FIG. 2, the polyester in the polyester layer 32 ends up making up between approximately 40 and 60 weight percent of the final dielectric material. According to other embodiments of the present invention, the polyester makes up approximately 10, 15, 20, 25, 30, 35, 45, 50, 55, 65, 70, 75, or 80 weight percent of the final dielectric material.

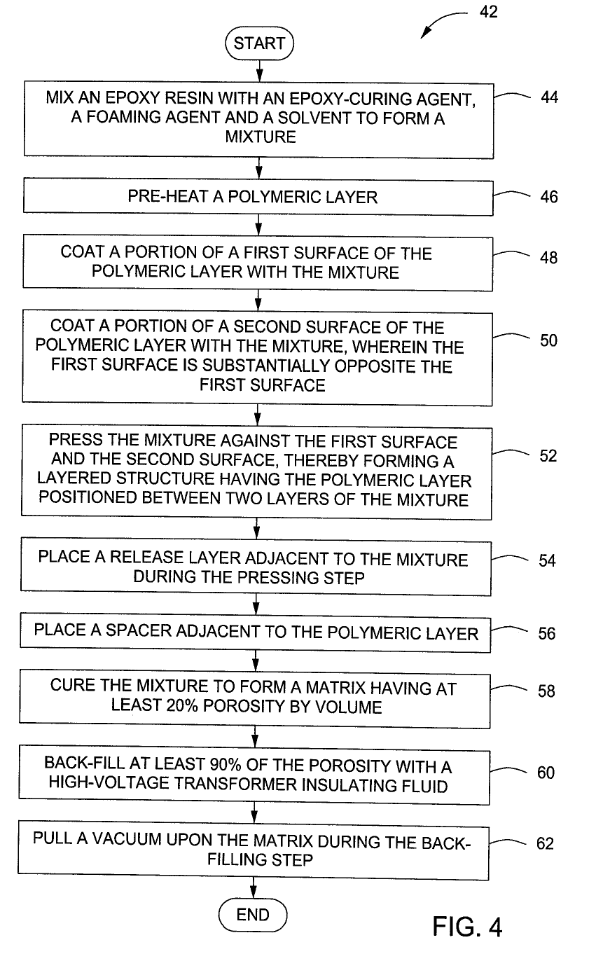

FIG. 4 is a flowchart 42 illustrating steps of a method of forming a dielectric material according to an embodiment of the present invention. As illustrated in step 44 of the flowchart 42, an epoxy resin is mixed with an epoxy-curing agent, a foaming agent and a solvent to form a mixture (e.g., mixture 20 illustrated in FIG. 1).

According to certain embodiments of the present invention, not all of the components listed in step 44 are added to the mixture. However, when present, the curing agent typically promotes solidification of the epoxy resin into the epoxy matrix 26 and the foaming agent typically promotes formation of the pores 28, 28′ illustrated in FIG. 2. Also, when present, the solvent typically acts to weaken the structure (i.e., the “walls”) of the epoxy matrix 26. This allows for more interconnections to develop between the pores 28 (i.e., causing more inter-pore “wall collapse”) as the foaming agent creates the pores 28.

According to step 46, a polymeric layer is pre-heated. According to certain embodiments of the present invention, this pre-heating step 46 may be used to accelerate the rate of curing of the epoxy matrix, to promote homogeneity of the epoxy matrix and/or to control the amount of porosity in the dielectric material that will ultimately be formed as the polymeric layer is cured.

Step 48 follows step 46 and specifies coating a portion of a first surface of the polymeric layer with the mixture. This coating step 48 may be performed, for example, by coating one side (e.g., either the top or bottom) of the polymeric layer 32 illustrated in FIG. 3 with some of the mixture 20 illustrated in FIG. 1. The mixture 20 may, for example, be sprayed or brushed onto the polymeric layer 32 during this first coating step 48.

Step 50 then specifies coating a portion of a second surface of the polymeric layer with the mixture, thereby forming a layered structure having the polymeric layer positioned between two layers of the mixture. Referring to FIG. 3, this second coating step may be performed, for example, by coating the side of the polymeric layer 32 that had not been coated during the first coating step 48.

Pursuant to the coating steps 48, 50, step 52 specifies pressing the mixture against the first surface and the second surface, thereby forming a layered structure having the polymeric layer positioned between two layers of the mixture. However, according to certain embodiments of the present invention, the pressing step 52 may be performed pursuant to only one surface being coated. Also, the pressing step 52 may be performed on the mixture only and without a polymeric layer ever being introduced into the process at all.

Step 54 of the flowchart 42 specifies placing a release layer adjacent to the mixture during the pressing step 52. With reference to FIG. 3, step 54 may be implemented by using one or more of the release layers 38. In operation, the release layers 38 allow the platen 36, 38 to be moved away from each other pursuant to the pressing step 52 without damaging the dielectric material that forms therebetween.

Step 56 next specifies placing a spacer adjacent to the polymeric layer. The placing step 56 may be implemented, for example, using one or more of the shims 40 illustrated in FIG. 3.

As illustrated in step 58, at any point after the mixing step 44, the mixture may be cured to form an epoxy matrix having at least 20% porosity by volume (e.g., epoxy matrix 26 illustrated in FIG. 2). This curing step 58 may include, for example, heating the mixture using a heated surface (e.g., platens 34, 36 illustrated in FIG. 3) placed in proximity to the mixture. According to certain embodiments of the present invention, substantially all of the solvent is evaporated during this curing step 58.

Step 60 of the flowchart 42 specifies back-filling at least 90% of the porosity with high-voltage dielectric insulating fluid. In order to implement step 60, a small amount of insulating fluid (e.g., insulating fluid 14 illustrated in FIG. 1) may be added to the epoxy resin, the epoxy-curing agent, the foaming agent and the solvent to form the mixture. As an epoxy matrix then forms, a significant portion of the insulating fluid present in the mixture coats pores of the matrix. Then, when an attempt is made to back-fill the porosity in the matrix with additional insulating fluid (e.g., by submerging the epoxy matrix in a bath of additional insulating fluid), the insulating fluid already on the pores of the matrix exhibits a “wicking” effect due to the favorable surface properties/energies of the coated pores. This results in the very high percentage of back-filling described in step 60.

According to step 62, a vacuum may be pulled upon the epoxy matrix during the back-filling step 60. According to some such embodiments, the vacuum may be pulled on one side of the dielectric material and insulating fluid on one or more other sides of the dielectric material is effectively “sucked into” the dielectric material.

The present invention will be further understood upon reference to the following non-limiting examples:

### EXAMPLE 1

Mix 100 g of an epoxy resin together with 20 g of MIBK, 2 g of a foaming agent and 28 g of a hardener. Allow the mixture to stand for approximately four minutes, then apply the mixture evenly onto a 50 g polymer mat that has been pre-heated to 80° C. Position the coated polymer mat and shims between two platen and press the platen together. Cure for approximately twenty minutes at a platen temperature of 95° C.

### EXAMPLE 2

Mix 100 g of an epoxy resin together with 20 g of MIBK, 2 g of an insulating fluid, 2 g of a foaming agent and 28 g of a hardener. Allow the mixture to stand for approximately four minutes, then apply the mixture evenly onto a 50 g polymer mat. Position the coated polymer mat and shims between two platen and press the platen together. Cure for approximately twenty minutes at a platen temperature of 100° C.

Upon practicing one or more embodiments of the present invention, one of skill in the art will appreciate that the devices and components within the scope of the present invention may readily be utilized as insulation systems or components of insulation systems for all dielectric-fluid-impregnated high-voltage power system apparatuses. Such apparatuses may include, for example, power transformers, shunt reactors, phase shifting transformers, circuit breakers, instrument transformers, bushings and other high-voltage devices. Materials according to certain embodiments of the present invention may also be used as insulation systems or components for, for example, gas-insulated, vacuum-insulated and cryogenic-fluid-filled power system apparatuses.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A dielectric material, comprising:
an epoxy matrix having a porosity of at least 20% by volume; and
a dielectric insulating fluid, wherein at least 90% of the porosity is accessible to the insulating fluid.

2. The dielectric material of claim 1, further comprising:
a polymer material that includes at least one of a polyester, a polyphenylene sulphide, an aramide, a polyetherimide, a polysulphone and a polyether sulphone, wherein the polymer material is adhered to the epoxy matrix.

3. The dielectric material of claim 2, wherein the polymer material makes up between approximately 30 and 60 weight percent of the dielectric material.

4. The dielectric material of claim 1, wherein the epoxy matrix is formed from an epoxy resin and a curing agent capable of curing the epoxy resin and wherein the curing agent comprises at least one of an aliphatic amine, an aromatic amine and a fatty polyamide.

5. The dielectric material of claim 2, wherein the polymer material comprises a thermoplastic polymer.

6. The dielectric material of claim 4, wherein the epoxy resin comprises at least one of a polyglycidyl compound and a phenol novolac epoxy.

7. The dielectric material of claim 4, wherein the porosity is formed using a foaming agent and wherein the foaming agent comprises at least one of methyl hydrogen siloxane.

8. The dielectric material of claim 1, wherein the insulating fluid comprises at least one of napthenic mineral oil, paraffinic based mineral oil, synthetic esters or natural esters.

9. The dielectric material of claim 7, wherein epoxy matrix is solidified from a mixture that includes a solvent and wherein the solvent includes at least one of methyl isobutyl ketone (MIBK) and methyl isoamyl ketone, toluene, n-butanoland xylene.

10. A method of forming a dielectric material, the method comprising:
mixing an epoxy resin with an epoxy-curing agent, a foaming agent and a solvent to form a mixture;
curing the mixture to form a matrix having at least 20% porosity by volume; and
back-filling at least 90% of the porosity with a high-voltage dielectric insulating fluid.

11. The method of claim 10, wherein the mixing step further comprises adding a small amount of the insulating fluid to the epoxy resin, the epoxy-curing agent, the foaming agent and the solvent to form the mixture.

12. The method of claim 10, further comprising:
coating a portion of a first surface of a polymeric layer with the mixture before the curing step is performed.

13. The method of claim 12, further comprising:
coating a portion of a second surface of the polymeric layer with the mixture before the curing step is performed, wherein the first surface is substantially opposite the first surface; and
pressing the mixture against the first surface and the second surface pursuant to the coating step but prior to the curing step, thereby forming a layered structure having the polymeric layer positioned between two layers of the mixture.

14. The method of claim 13, further comprising:
placing a spacer adjacent to the polymeric surface.

15. The method of claim 10, further comprising:
pulling a vacuum upon the matrix during the back-filling step.

16. The method of claim 13, further comprising:
placing a release layer adjacent to the mixture during the pressing step.

17. The method of claim 10, wherein the curing step comprises heating the mixture using a heated surface placed in proximity to the mixture.

18. The method of claim 12, further comprising:
pre-heating the polymeric layer before the coating step.

19. The method of claim 10, wherein substantially all of the solvent is evaporated during the curing step.

20. A dielectric material, comprising:
means for mixing an epoxy resin with an epoxy-curing agent, a foaming agent and a solvent to form a mixture;
means for curing the mixture to form a matrix having at least 20% porosity by volume; and
means for back-filling at least 90% of the porosity with a high-voltage dielectric insulating fluid.
